(19) United States
(12) Patent Application Publication
(10) Pub. No.: US 2015/0193046 A1
(43) Pub. Date: Jul. 9, 2015

(54) CAPACITIVE TRANSPARENT TOUCH SHEET HAVING EXCELLENT VISIBILITY AND DURABILITY

(71) Applicant: NISSHA PRINTING CO., LTD., Kyoto-shi, Kyoto (JP)

(72) Inventors: Katsumi Tokuno, Kyoto (JP); Takanori Yoshida, Kyoto (JP); Yoshihiro Nii, Kyoto (JP); Takako Ueno, Kyoto (JP); Yuhei Abe, Kyoto (JP); Tsunetomo Aisaka, Kyoto (JP); Eiko Seki, Kyoto (JP); Yoko Kawashima, Kyoto (JP); Kaori Maenaka, Kyoto (JP); Kazumasa Takahashi, Kyoto (JP)

(21) Appl. No.: 14/403,993

(22) PCT Filed: May 28, 2013
(86) PCT No.: PCT/JP2013/064809

§ 371 Date: Nov. 25, 2014

(30) Foreign Application Priority Data
May 28, 2012 (JP) 2012-121308

(51) Int. Cl. G06F 3/044

(52) U.S. Cl. CPC G06F 3/044; G06F 2203/04103

(57) ABSTRACT

A capacitive transparent touch sheet has excellent visibility and durability without changing the sensitivity, size, or the like of a touch panel. A capacitive transparent touch sheet is a capacitive transparent touch sheet that comprises: a substrate; strip shaped first electrodes comprising a transparent metal oxide and formed separately on a first surface of the substrate; strip shaped second electrodes formed on a second surface of the substrate opposite to the first surface and to cross the first electrodes; and at least one insulation part formed continuously with the second electrodes and having a thickness the same as that of the second electrodes. The second electrodes comprise conductive nanofibers conductively connected with each other, and a binder resin for holding the conductive nanofibers on the substrate; and the at least one insulation part comprises the binder resin that constitutes the second electrodes without the conductive nanofibers.

This U.S. National stage application claims priority under 35 U.S.C. §119(a) to Japanese Patent Application No. 2012-121308, filed in Japan on May 28, 2012, the entire contents of Japanese Patent Application No. 2012-121308 are hereby incorporated herein by reference.

### BACKGROUND

1. Field of the Invention

The present invention relates to a capacitive transparent touch sheet used in a capacitive touch panel and more particularly relates to a capacitive transparent touch sheet having high durability and wherein electrodes, which are formed in the capacitive transparent touch sheet, are not visualized as a pattern when the capacitive transparent touch sheet is adhered onto a transparent base material.

2. Background Information

Conventionally, capacitive touch panels are used as touch panels. FIG. 7 is an exploded oblique view of a conventional capacitive touch panel, and FIG. 8 is a plan view of the conventional capacitive touch panel. With reference to FIG. 7, a conventional capacitive touch panel 200 is configured by adhering together an upper part conductive sheet α, which comprises an upper part base material 100 and upper part electrodes 101, and a lower part conductive sheet β, which comprises a lower part base material 110 and lower part electrodes 111. Furthermore, the upper part conductive sheet α and the lower part conductive sheet β are adhered together such that the upper part electrodes 101 and the lower part electrodes 111 cross one another (See, e.g., Japanese Unexamined Patent Application Publication No. H7-171408).

However, the upper part electrodes 101 and the lower part electrodes 111 are formed separately and both have a constant thickness. With reference to FIG. 8, consequently, in the conventional capacitive touch panel 200, the thickness of the locations at which the upper part electrodes 101 and the lower part electrodes 111 cross (the thickness of intersecting portions γ between the upper part electrodes 101 and the lower part electrodes 111) is greater than the thickness of locations δ at which the upper part and lower part electrodes 101, 111 are not formed.

As a result, steps arise in the surface of the touch panel 200, and therefore, there is a problem in that, when light is radiated to the touch panel 200, the shimmering light is refracted by the step portions and the entire touch panel 200 adversely appears as if it is wavy.

Furthermore, there is a problem in that, because the intersecting portions γ are thicker than the other portions and form protruding shapes, fatigue accumulates over repeated use and thereby short circuit adversely occur during usage.

To solve the aforementioned problems, a method is known that adheres a cushioning sheet, which eliminates the steps, to the surface of the upper part conductive sheet α or the lower part conductive sheet β; however, in this method, there is a problem in that the overall thickness of the touch panel 200 increases, and therefore the touch panel 200 cannot be made compact.

In addition, there is also another method that improves the visibility of the touch panel 200 by reducing the thickness of the upper part electrodes 101 and the lower part electrodes 111, thereby reducing the steps created at the intersecting portions γ as much as possible; however, in this method, there is a problem in that, because the resistance value of the electrodes adversely increases commensurately with the reduction in the thickness of the electrodes, the sensitivity of the touch panel 200 adversely decreases.

### SUMMARY

The present invention solves the aforementioned problem with the conventional art, and an object of the present invention is to provide a capacitive transparent touch sheet having excellent visibility and durability without changing the sensitivity and/or the size of the touch panel.

The abovementioned technical solution is described below.

A capacitive transparent touch sheet for adhering to a transparent hard substrate according to one disclosed non-limiting embodiment of the present disclosure includes: a substrate; a plurality of strip shaped first electrodes formed separately on the substrate; a plurality of strip shaped second electrodes formed on a surface of the substrate opposite to the surface where the first electrodes are formed, and arranged to cross the first electrodes; and at least one insulation part formed continuously with the second electrodes, the at least one insulation part having a thickness the same as that of the second electrodes; wherein, the first electrodes consist of a transparent metal oxide; the second electrodes comprise a plurality of conductive nanofibers, in a state where the plurality of conductive nanofibers are conductively connected with each other, and a binder resin for holding the plurality of conductive nanofibers on the substrate; and the at least one insulation part comprises the binder resin that constitutes the second electrodes without the conductive nanofibers.

A further embodiment of the present disclosure includes, wherein the thickness of the second electrodes is greater than the thickness of the first electrodes.

A further embodiment of any of the foregoing embodiments of the present disclosure includes, wherein the width of each of the second electrodes is greater than the width of the at least one insulation part.

A further embodiment of any of the foregoing embodiments of the present disclosure includes, wherein the transparent metal oxide is ITO.

A further embodiment of any of the foregoing embodiments of the present disclosure includes, wherein the conductive nanofibers include silver.

A further embodiment of any of the foregoing embodiments of the present disclosure includes, wherein a hard coat layer is formed on a side of the substrate opposite to the surface where the first electrodes are formed.

A capacitive transparent touch panel according to one disclosed non-limiting embodiment of the present disclosure includes: the capacitive transparent touch sheet according to any of the foregoing embodiments of the present disclosure; and a transparent base material is adhered onto the substrate of the capacitive transparent touch sheet.

The capacitive transparent touch sheet of the present invention has excellent visibility and durability without changing the sensitivity and/or the size of the touch panel.

### BRIEF DESCRIPTION OF THE DRAWINGS

FIG. 1 is an oblique view of a capacitive transparent touch sheet according to a disclosed embodiment;

FIG. 2 is a cross sectional enlarged view of FIG. 1;

FIG. 3 is a cross sectional enlarged view of FIG. 1;

FIG. 4 is a cross section that shows the point in time when the capacitive transparent touch sheet shown in FIG. 1 is adhered to a transparent base material;

FIG. 5 is a cross sectional view of the capacitive transparent touch sheet as shown in FIG. 1;

FIG. 6 is a cross sectional view of a capacitive transparent touch panel employing the capacitive transparent touch sheet shown in FIG. 1;

FIG. 7 is an exploded oblique view of a conventional capacitive transparent touch sheet; and

FIG. 8 is a plan view of the conventional capacitive transparent touch sheet.

### DETAILED DESCRIPTION OF EMBODIMENTS

Embodiments according to the present invention are explained in further detail below, based on the drawings. Furthermore, the dimensions, materials, or shapes of the areas, portions, and the like described in the working examples of the present invention, and their relative positions and the like, are merely explanatory examples that, unless particularly and specifically noted, do not purport to limit the scope of the present invention.

### First Embodiment

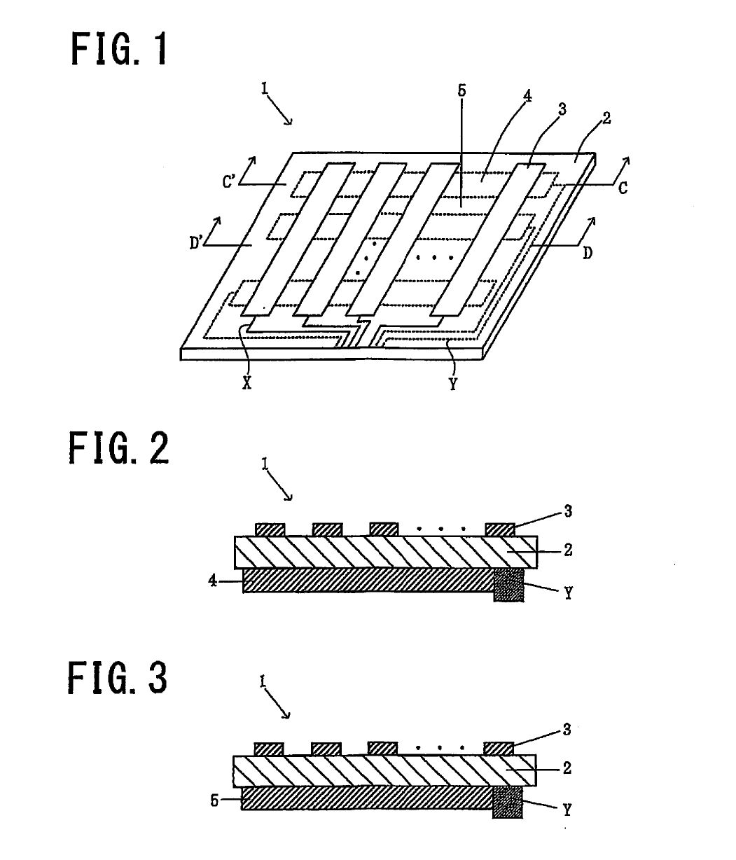

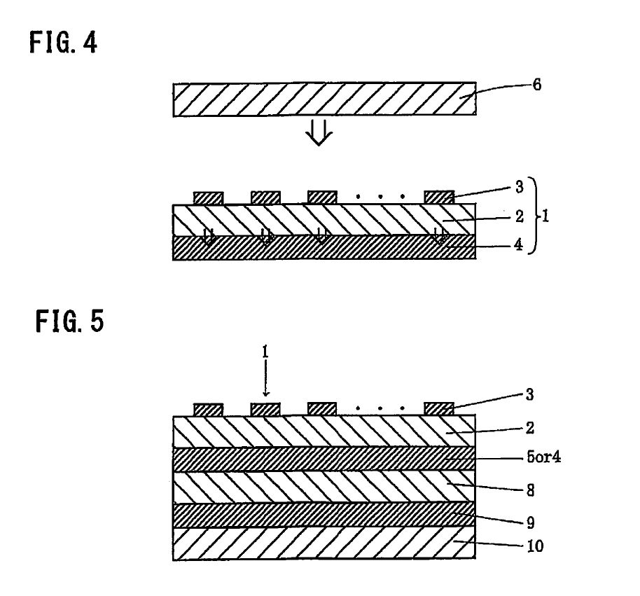

FIG. 1 is an exploded oblique view of a capacitive transparent touch sheet 1 according to a first embodiment. Furthermore, in FIG. 1, the dotted line portions indicate structures on the reverse surface side of a substrate 2. FIG. 2 is a cross sectional view taken along the C-C′ line of the capacitive transparent touch sheet 1 in FIG. 1. FIG. 3 is a cross sectional view taken along the D-D′ line of the capacitive transparent touch sheet 1 in FIG. 1. Furthermore, the cross section taken along the C-C′ line is a cross sectional view that shows a section of the capacitive transparent touch sheet 1 cut along second electrodes 4, and the cross section taken along the D-D′ line is a cross sectional view that shows the capacitive transparent touch sheet 1 cut along insulation parts 5. FIG. 4 is a cross sectional view that shows the point in time when the capacitive transparent touch sheet 1 of the first embodiment is adhered to a transparent base material 6. With reference to FIG. 1, each of the insulation parts 5 is a region which is located between each pair of adjacent second electrodes 4.

With reference to FIG. 1, the capacitive transparent touch sheet 1 comprises: a substrate 2; a plurality of strip shaped first electrodes 3 formed separately on one surface of the substrate 2; first lead circuits X that electrically connect the first electrodes 3 externally; the strip shaped second electrodes 4 formed on the rear surface of the substrate 2 with the first electrodes 3 formed such that the second electrodes 4 cross the first electrodes 3; the insulation parts 5 formed continuously with the second electrodes 4 and whose thickness is the same as that of the second electrodes 4; and second lead circuits Y that electrically connect the second electrodes 4 externally.

With reference to FIG. 1, FIG. 2, and FIG. 3, the capacitive transparent touch sheet 1 of the first embodiment differs from a conventional touch sheet in that the insulation parts 5 are formed on the surface of the substrate 2 on the side whereon the second electrodes 4 are formed such that the insulation parts 5 have the same thickness as the second electrodes 4. In addition, it also differs in that the insulation parts 5 are formed continuously with the second electrodes 4. By adopting such a configuration, in the capacitive transparent touch sheet 1 of the first embodiment, the surface on the second electrodes 4 side of the substrate 2 becomes smooth. Thereby, the steps that appear on the surface of the capacitive transparent touch sheet 1 can be reduced. As a result, when shimmering light is radiated, it is possible to prevent the entire capacitive transparent touch sheet 1 from appearing as if it is wavy.

Furthermore, if the surface of the substrate 2 on the side whereon the second electrodes 4 are formed becomes smooth, then the difference between the thickness of the intersecting portions between the first electrodes 3 and the second electrodes 4 and the thickness of the other portions becomes small. As a result, compared with conventional capacitive transparent touch sheets, fatigue tends not to accumulate at the intersecting portions, which makes it possible to also reduce the incidence of the problem wherein a short circuit adversely occurs during usage of the capacitive transparent touch sheet 1.

In addition, there is also a difference in that the first electrodes 3 are formed on one surface of the substrate 2, and the second electrodes 4 are formed on the surface on the opposite side. By adopting such a configuration, there is no longer a need to use two substrates, and therefore the thickness of the capacitive transparent touch sheet 1 is reduced commensurately.

The components that constitute the capacitive transparent touch sheet 1 are explained below.

### <Substrate>

Resin films, such as acrylic, polycarbonate, polyester, polybutylene terephthalate, polypropylene, polyimide, polyurethane, polyvinyl chloride, polyvinyl fluoride, and polyimide, can be given as examples of the material of the substrate 2. The thickness of the substrate 2 can be set, as appropriate, in the range of 5-800 μm. If the thickness is less than 5 μm, handling becomes difficult because the strength as a layer is insufficient and therefore the layer tears when it is peeled; if the thickness exceeds 800 μm, the layer is too stiff, and therefore fabrication becomes difficult and it is no longer possible to obtain flexibility.

### <First Electrodes and Second Electrodes>

In FIG. 1, the first electrodes 3 and the second electrodes 4 each comprise a plurality of strip shaped electrodes, but the electrodes are not limited to being strip shaped. For example, the first electrodes 3 may comprise a plurality of rhombic electrodes connected in diagonal directions, and the second electrodes 4 may comprise a plurality of rhombic electrodes connected in diagonal directions. In such a case, the rhombic electrodes that constitute the first electrodes 3 and the rhombic electrodes that constitute the second electrodes 4 may be disposed such that they do not overlap one another when viewed from a direction normal to the surface. By thusly disposing the first electrodes 3 and the second electrodes 4 such that they do not overlap, the detection sensitivity in the transverse directions and the detection sensitivity in the longitudinal directions can be made such that they do not affect one another. In addition, in FIG. 1, a plurality of the first electrodes 3 and a plurality of the second electrodes 4 are provided, but the present invention is not limited thereto and an arbitrary number of each can be provided.

Any appropriate material can be used as the material of the first electrodes 3 and the second electrodes 4, as long as the material is electrically conductive. Preferably, as a combination of materials that constitute the first electrodes 3 and the second electrodes 4, the first electrodes 3 comprise a transparent metal oxide, and the second electrodes 4 comprise an electrically conductive material made of a photosetting resin binder and conductive nanofibers.

ITO can be given as an example of the transparent metal oxide. Examples that can be given as the conductive nanofibers are: a metal nanowire that is prepared by impressing a voltage or an electric current from a tip part of a probe to the surface of a precursor that supports a metal ion, such as gold, silver, platinum, copper, palladium, or the like, and then continuously drawing the nanowire; a peptide nanofiber, which is made by adding metal particles to a nanofiber that is formed by the self-assembly of a peptide or a derivative thereof; or the like. In addition, even blackish conductive nanofibers, such as carbon nanotubes, can be used if a difference can be discerned in, for example, the color, the reflectivity, or the like at the shadow. In addition, urethane acrylate, cyanoacrylate, or the like can be given as examples of the photosetting resin binder.

Furthermore, among those described above, as yet a more preferable combination, ITO may be used as the transparent metal oxide, silver nanofibers may be used as the conductive nanofibers, and urethane acrylate may be used as the photosetting resin binder.

If configured in this manner, the transparency of the first electrodes 3 and the second electrodes 4 increases. Furthermore, the transparency of the first electrodes 3 becomes greater than that of the second electrodes 4. As a result, it is possible to eliminate the problem of the visualization of the pattern of the first electrodes 3 because the shape of the first electrodes 3, the pattern of which naturally has high transparency and therefore tends not to be visualized, is concealed further by the second electrodes 4, whose transparency is lower than that of the first electrodes 3. In addition, the problem of pattern visualization does not occur for the second electrodes 4. This is because the insulation parts 5, whose thickness is the same as that of the second electrodes 4 and whose material is substantially the same as that of the second electrodes 4, are disposed in an area adjacent to the second electrodes 4, and therefore there is virtually no difference in the transparency, the refractive index, and the like between the second electrodes 4 and the insulation parts 5. As a result, if the first electrodes 3 and the second electrodes 4 are configured with the materials mentioned above, it is possible to produce a capacitive transparent touch sheet wherein the overall transparency is high and the pattern visualization of electrodes is extremely unlikely.

The thicknesses of the first electrodes 3 and the second electrodes 4 can be appropriately set in the range of several tens of nanometers to several hundred nanometers. If the thickness is less than several tens of nanometers, then the strength as a layer is insufficient; furthermore, if the thickness is greater than several hundred nanometers, then the flexibility becomes insufficient.

Furthermore, the thickness of the second electrodes 4 is preferably greater than the thickness of the first electrodes 3. With reference to FIG. 4, if the thickness of the second electrodes 4 is greater than the thickness of the first electrodes 3, then, when the capacitive transparent touch sheet 1 is adhered to the transparent base material 6, the second electrodes 4 can incorporate the thickness of the first electrodes 3. As a result, the shape of the first electrodes 3 is no longer reflected in the surface of the capacitive transparent touch sheet 1 (the surface of the substrate 2 on the second electrodes 4 side). Thereby, the surface of the capacitive transparent touch sheet 1 (the surface of the substrate 2 on the second electrodes 4 side) becomes smooth. In so doing, even if light is radiated to the capacitive transparent touch sheet 1, the shimmering light is no longer refracted at the surface, and therefore the entire capacitive transparent touch sheet 1 no longer appears as if it is wavy. Furthermore, it is also possible to prevent the electrodes 3, 4 from fatiguing at the intersecting portions between the first electrodes 3 and the second electrodes 4.

In addition, the thickness of the second electrodes 4 is preferably the same as that of each of the insulation parts 5 and is preferably in the range of 1-50 μm. If it is less than 1 μm, then there are cases in which the electrical conductivity of the second electrodes 4 is insufficient; if the thickness exceeds 50 μm, then the second electrodes 4 are too thick, which results in the problem wherein the capacitive transparent touch sheet 1 cannot be made compact.

In addition, the width of the second electrodes 4 is preferably greater than the width of each of the insulation parts 5. If the width of the second electrodes 4 is less than the width of each of the insulation parts 5, then the problem arises wherein the capacitive transparent touch sheet 1 cannot be produced with high sensitivity because the portions that function as sensors are too narrow.

### <Insulation Part>

The width of each of the insulation parts 5 is preferably approximately 10-100 μm. The lower limit is set to 10 μm because, if the insulation parts 5 are formed with a width of less than 10 μm, then ion migration occurs during use, which creates a short circuit between electrodes. Moreover, the upper limit is set to 100 μm because, if the width exceeds 100 μm, then, for example, the insulation parts 5 can adversely be visually discerned when illuminated, the sensitivity of the capacitive transparent touch sheet 1 would adversely decrease, and the like. In addition, the depth of the insulation parts 5 is the same as the thickness of the second electrodes 4, and the resin material of the insulation parts 5 is the same as the binder resin that constitutes the second electrodes 4.

### <Adhesive Layer>

An adhesive layer 8 is a layer for adhering the capacitive transparent touch sheet 1. A resin having thermosensitivity and pressure sensitivity suited to the type of the substrate 2 may be used as the material of the adhesive layer 8. Specifically, a resin such as a PMMA based resin, PC, polystyrene, PA based resin, a poval based resin, a silicone based resin, or the like may be used. Furthermore, the adhesive layer is formed on the substrate 2 by a gravure coating method, a roll coating method, a comma coating method, a gravure printing method, a screen printing method, an offset printing method, or the like.

Furthermore, instead of the adhesive layer 8 formed between the capacitive transparent touch sheet 1, a double-sided adhesive sheet comprising the abovementioned resin may be used.

FIG. 5 is a cross sectional view of the capacitive transparent touch sheet 1 according to another working example of the first embodiment. With reference to FIG. 5, in the capacitive transparent touch sheet 1 of the present embodiment, a hard coat layer 10 is formed on a side of the substrate 2 on which the second electrodes 4 are formed, with an adhesive layer 8 and a transparent film 9 interposed therebetween.

### <Hard Coat Layer>

The hard coat layer 10 is a layer that is disposed on the surface of the touch panel when the touch panel is produced using the capacitive transparent touch sheet 1. By disposing the hard coat layer 10 on the surface of the touch panel, the capacitive transparent touch sheet 1 can be protected from physical or chemical damage. That is, the damage resistance, the chemical resistance, and the like of the touch panel surface can be improved.

The film thickness of the hard coat layer 10 is preferably in the range of 1-20 μm. If the film thickness of the hard coat layer 10 is less than 1 μm, then it is too thin, and consequently the abovementioned functions can no longer be sufficiently exhibited. Conversely, if the film thickness of the hard coat layer 10 exceeds 20 μm, then the hard coat layer 10 will no longer dry immediately, which is not preferable from the viewpoint of production efficiency.

In addition to an acrylic—such as polymethyl methacrylate, polyethyl methacrylate, polyethyl acrylate, or polybutyl acrylate—a methacryl monomer homopolymer, or a copolymer acrylic based resin containing these monomers, it is also possible to use a melamine based resin, an acrylic based resin, a urethane based resin, an epoxy based resin, or the like as the material of the hard coat layer.

Specifically, it is possible to use, for example: a one-liquid curing type resin such as melamine, acrylic melamine, epoxy melamine, alkyd, urethane, acrylic, or the like; a resin that is a mixture of these; a two-liquid curing type resin made by combining any of the aforementioned with a curing agent, such as isocyanate; or an ultraviolet light or electron beam setting resin comprising a monomer, a prepolymer, or the like having an ethylenic unsaturated bond, such as polyester acrylate, polyester methacrylate, epoxy acrylate, epoxy methacrylate, urethane acrylate, urethane methacrylate, polyether acrylate, polyether methacrylate, polyol acrylate, melamine acrylate, melamine methacrylate, or the like. Furthermore, if an ultraviolet light setting resin is used, then a photoinitiator is further added.

Next, a conductive nanofiber sheet manufacturing method according to the first embodiment will be explained.

### <Capacitive Transparent Touch Sheet Manufacturing Method>

The method for manufacturing the capacitive transparent touch sheet 1 includes the processes below.

(a) Prepare the substrate 2.

(b) Form an electrically conductive layer, which is made of ITO, on one surface of the substrate.

(c) Using a photoresist method or the like to pattern the electrically conductive layer to form the first electrodes 3 on the substrate 2.

(d) Using a printing method to form an electrically conductive layer, which includes the conductive nanofibers, on the rear surface of the substrate 2, opposite to where the first electrodes 3 are formed.

(e) Radiate an energy ray, for example, a laser, to part of the electrically conductive layer, which includes the conductive nanofibers, to form the insulative layer wherein some of the conductive nanofibers have been removed. The insulation parts 5 are formed by radiating an energy ray, such as a carbon dioxide gas laser having a spot diameter of several tens of microns, to break up the conductive nanofibers. Thereby, the capacitive transparent touch sheet 1 is obtained wherein the second electrodes 4 and the insulation parts 5 are formed on the rear surface of the substrate 2 opposite to where the first electrodes 3 are formed.

Furthermore, other than the method that forms the insulation parts 5 using the abovementioned laser, there may be, for example: a method that uses a photosetting resin in the binder resin, causes the photosetting resin to produce its effects by the irradiation of light, and develops the unset resin, thereby eliminating such; and a method that forms an etching resist layer made of an alkyd resin, a polyester resin, an epoxy resin, or the like on part of the electrically conductive layer, then etches the entire surface of the etching resist layer by an acid, an alkaline aqueous solution, or the like, and removes, by etching, the part of the electrically conductive layer on which the etching resist layer is not formed.

However, if a photosetting resin is used in the abovementioned binder resin or if an etching method is used, then there is a problem in that the width of each of the insulation parts 5 cannot be made smaller than a certain degree. Consequently, the number of the second electrodes 4 that can be formed on the substrate 2 is limited.

Accordingly, in the capacitive transparent touch sheet manufacturing method of the first embodiment, the insulation parts 5 are formed using a laser. Using laser makes it possible to form the insulation parts 5 with a width such that the insulation parts 5 cannot be visually discerned. Consequently, the number of the second electrodes 4 can be increased.

In the capacitive transparent touch sheet 1 obtained by the method above, the second electrodes 4 and the insulation parts 5 are formed continuously, and the difference in the materials that constitute the two lies only in the presence/absence of the conductive nanofibers, and therefore there is virtually no difference in their transmittance and refractive index. Consequently, the pattern visualization of the second electrodes 4 and the insulation parts 5 can be reduced considerably. In addition, if the capacitive transparent touch sheet 1 prepared by this method is used, it is possible to manufacture a capacitive type touch panel wherein the transmittance of the display screen is uniform and the reduction in pattern visualization of the first electrodes 3, the second electrodes 4, and the insulation parts 5 are excellent.

### <Capacitive Touch Panel>

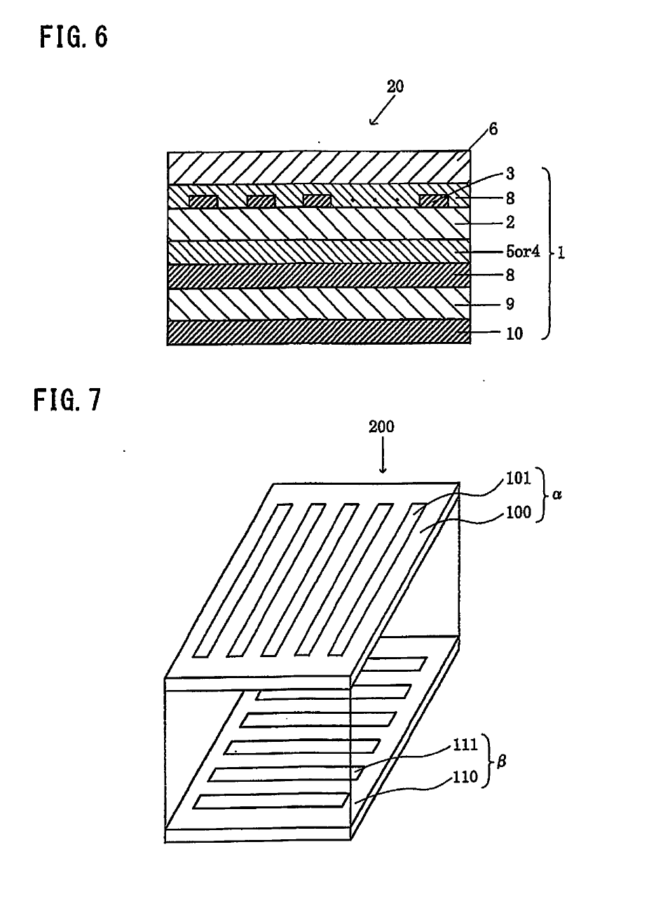

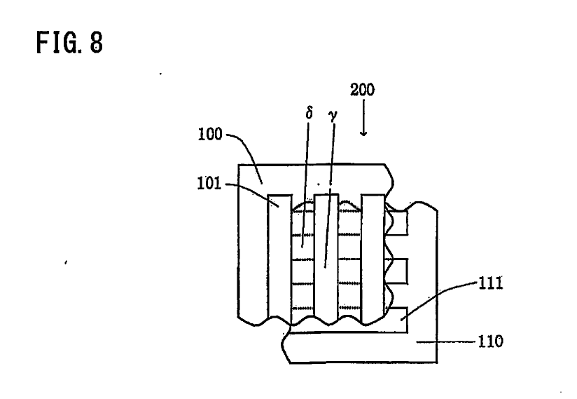

FIG. 6 is a cross sectional view of a capacitive touch panel 20 that uses the capacitive transparent touch sheet 1 of the first embodiment. The basic configuration of the capacitive touch panel 20 is the same as that of the first embodiment, and therefore only points that are different from those of the first embodiment will be explained below. In the capacitive touch panel 20 of the present embodiment, the capacitive transparent touch sheet 1 of the first embodiment is adhered to the transparent base material 6. Furthermore, with regard to the capacitive transparent touch sheet 1 and the transparent base material 6, the transparent base material 6 and the surface of the substrate 2 on the side where the first electrodes 3 are formed are adhered to one another with the adhesive layer 8 interposed therebetween.

1. A capacitive transparent touch sheet comprising:
a substrate;
a plurality of strip shaped first electrodes formed separately on the substrate;
a plurality of strip shaped second electrodes formed on a surface of the substrate opposite to the surface where the first electrodes are formed, and arranged to cross the first electrodes; and
at least one insulation part formed continuously with the second electrodes, the at least one insulation part having a thickness the same as that of the second electrodes;
the first electrodes comprising a transparent metal oxide;
the second electrodes comprising a plurality of conductive nanofibers, in a state where the plurality of conductive nanofibers are conductively connected with each other, and a binder resin for holding the plurality of conductive nanofibers on the substrate; and
the at least one insulation part comprising the binder resin that constitutes the second electrodes substantially without the conductive nanofibers.

2. The capacitive transparent touch sheet according to claim 1, wherein
the thickness of the second electrodes is greater than the thickness of the first electrodes.

3. The capacitive transparent touch sheet according to claim 1, wherein
the width of each of the second electrodes is greater than the width of the at least one insulation part.

4. The capacitive transparent touch sheet according to claim 1, wherein
the transparent metal oxide is ITO.

5. The capacitive transparent touch sheet according to claim 1, wherein
the conductive nanofibers include silver.

6. The capacitive transparent touch sheet according to claim 1, further comprising:
a hard coat layer formed on surface side of the substrate opposite to the surface on which the first electrodes are formed.

7. A capacitive transparent touch panel comprising:
the capacitive transparent touch sheet according to claim 1; and
a transparent base material is adhered onto the substrate of the capacitive transparent touch sheet.
